(19) United States
(12) Patent Application Publication
(10) Pub. No.: US 2008/0317408 A1
(43) Pub. Date: Dec. 25, 2008

(54) Fibre or Filament

(75) Inventors: Alwin R.M. Verschueren, 'S-Hertogenbosch (NL); Martijn Krans, Den Bosch (NL); Sander J. Roosendaal, Geldrop (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,142

(22) PCT Filed: Sep. 15, 2005
(86) PCT No.: PCT/IB2005/053027

§ 371 Date: Mar. 13, 2007

(30) Foreign Application Priority Data
Sep. 17, 2004 (GB) 0420705.6

(51) Int. Cl. G02B 6/26; F21V 9/16

(52) U.S. Cl. 385/41; 362/84

(57) ABSTRACT

A fibre or filament comprising an electro-optically active layer; a first electrode; a second electrode; the electro-optically active layer being positioned at least partially between the first and second electrodes; the fibre or filament further comprising control means for controllably varying the optical state of a predetermined region of the fibre or filament, such that the length of the predetermined region may be controlled.

This invention relates to a fibre or filament, especially one that is suitable for inclusion in a fabric or garment having one or more indicator displays incorporated therein.

Various types of fibres and filaments formed from electro-optical materials which are capable of undergoing colour change are known. For example it is known to form a fibre or filament from an electro-optically active material such as an electro-luminescent material or a polymer LED material. It is also possible to use liquid crystals, electrophoretic particles or electrochrome materials as the electro-optic material forming the fibre or filament.

In general, all known fibres and filaments of this type have the same basic structure and comprise:

1. A conducting core or electrode generally running axially through the fibre or filament at or towards the centre of the fibre or filament;

2. An electro-optic layer coating the core electrode; and

3. A transparent conducting outer electrode.

By applying a voltage difference between the core electrode and the outer electrode, an electric field is generated in the electro-optic layer, over the entire length of the fibre. The electric field produced is homogeneous, in a direction along the fibre, and induces a change in the optical state of the electro-optical layer. The change in the optical state is dependent on the material forming the electro-optic layer, and the field applied across the electrodes.

It is an object of the present invention to provide a fibre or filament in which the length of the optically active part of the fibre or filament can be controlled by tuning the voltage difference applied across the electro-optically active layer.

According to a first aspect of the present invention there is provided a fibre or filament comprising an electro-optically active layer;
a first electrode;
a second electrode;
the electro-optically active layer being positioned at least partially between the first and second electrodes;
the fibre or filament further comprising
control means for controlling the optical state of a predetermined region of the fibre or filament, such that the length of the predetermined region may be controlled.

By means of the present invention it is possible to control the optical state of a predetermined region of the fibre or filament in such a way that the length of the predetermined region may be controlled.

The optical state at a position within a fibre or filament is characterised by the light that is emitted, reflected or absorbed by the electro-optically active layer. It is to be understood that the present invention as claimed relates to fibres or filaments having electro-optically active layers that reflect or absorb light from both internal or external light sources.

In use, the optical state of the predetermined region may be such that it emits light when no other parts of the fibre emits light.

This is in sharp contrast to known colour change fibres or filaments in which it is only possible to change the optical state of the electro-optically active layer homogeneously over the entire length of the electrodes. In practice this means that the optical state in a known colour change fibre is the same along the entire length of the fibre.

This means that for example when the electro-optically active layer is formed from a material having a threshold voltage above which it is in an on state, and below which it is in an off state, in a known colour change fibre, the entire fibre will either be in the off state emitting no light or the on state emitting light.

By means of the present invention, it is possible to vary the optical state of the electro-optically active material along the length of the fibre or filament so that a variable length of the fibre or filament may be in the on state and therefore emitting light at any given time.

The predetermined region of the fibre or filament may comprise a portion only of the fibre or filament or may comprise the entire fibre or filament.

The present invention is particularly suited for use as an indicator, or as an indicator incorporated into a garment.

Advantageously, the fibre or filament comprises voltage means for applying a voltage difference across the electro-optically active layer.

Preferably, the control means controllably varies the voltage difference applied across the electro-optically active layer, along the length of the fibre.

The voltage difference may be a direct voltage difference, or an AC voltage difference.

Preferably, the fibre or filament is substantially cylindrical.

Advantageously, the first electrode is positioned at or close to a central portion of the fibre or filament, and the second electrode is positioned at or close to an outer surface of the fibre or filament.

Advantageously the first electrode extends substantially along the axis of the fibre or filament.

Conveniently, the second electrode comprises a first conducting coating which, in a preferred embodiment is transparent.

Preferably, the electro-optically active layer comprises an electroluminescent material, although other types of electro-optically active material could also be used.

Alternatively, the electro-optically active layer could comprise a light emitting polymer (poly LED), liquid crystal material, electrophoretic particle suspensions or electrochrome material.

The optical state of an electroluminescent material may be altered by varying an electric field applied across the electroluminescent material. The material has a threshold voltage typically of about 200 volts. When electric fields of below the threshold voltage are applied to the material, the material remains in an off state, and does not emit light. When electric fields above the threshold level are applied across the material, the material switches into an on state in which it emits light.

Preferably, the control means comprises a conductor extending between the first and second electrodes.

The conductor may take any convenient form and may for example be in the shape of a disc extending through the electro-optically active material from the first electrode to the second electrode.

The conductor thus serves to create a short circuit between the first electrode and the second electrode. This in turn means that if a voltage difference is applied across the first and second electrodes, the strength of the field created in the electro-optically active layer will decrease towards the conductor.

This in turn means that, since the optical state of the electro-optically active material is governed by the strength of the field existing in the material, the optical state of the electro-optically active material will vary with the voltage difference applied along the length of the first and second electrodes.

One of the first and second electrodes may be formed from a material with a higher resistance.

Resistive electrodes can be made from Titanium (ρ=5.6·10⁻⁷ Ωm) or Nickel-Chrome alloys, such as Inconel (ρ=9.8·10⁻⁷ Ωm) or Nichrome (ρ=11·10⁻⁷ Ωm).

Alternatively, the fibre may be manufactured as such that it has appropriate dimensions to provide a sufficiently high resistance. For instance, a very thin wire made from copper (ρ=0.17·10⁻⁷ Ωm) that has a diameter of 20 μm (corresponding to the American Wire Gauge standard 52) has a resistance that is 100 times larger than a copper wire with a more conventional diameter of 200 μm (corresponding to the American Wire Gauge standard 32). A 20 μm thin copper wire has a comparable resistance to a 200 μm thick wire made out of Nichrome.

In such embodiments of the invention, the electric field across the first and second electrodes, and therefore across the electro-optically active layer will decrease gradually along the length of the fibre or filament.

Advantageously, the first or second electrode is divided in a plurality of length segments comprising at least a first length segment and a last length segment which first and last length segments are positioned at or towards opposite ends of the first electrode.

In one embodiment of the invention, the control means may comprise a first resistor positioned between a pair of adjacent length segments. Preferably the control means comprises a plurality of first resistors, each of which first resistors is positioned between respective pairs of adjacent length segments. Advantageously the control means further comprises a second resistor associated with the last length segment.

In such an embodiment, the conductor is preferably positioned at or close to the last length segment.

Each length segment of the electro-optical layer may be modelled by a parallel connection between the first and second electrodes via the resistance (R_{fibre}) and the capacitance (C_{fibre}) of the electro-optical layer. Each length segment of the first or second electrode together with each resistor forms a resistive element having a resistance R_{wire}. When the resistance of a resistive element (R_{wire}) is chosen such that it is lower than R_{fibre}, then a DC voltage applied to the first electrode will linearly divide over the length of the first electrode.

In another embodiment, an AC voltage is used to drive the electro-optically active layer. When an AC voltage is used, the impedance of the resistive elements (length segment and resistor) should be lower than the total impedance of the electro-optically active layer. In other words the impedance of each resistive element, R_{wire}, should be lower than both R_{fibre} and 1/(2πfC_{fibre}).

Due to the presence of the resistive elements, when a voltage difference is applied across the first and second electrodes, power is not uniformly distributed over the entire fibre. The first segment receives more power than the second segment and the second more than the third and so on, to the last segment. This means that up to a certain voltage difference, only the first segment will be in the on state. As the voltage difference increases, the second segment will also emit light, and so on to the last segment, assuming that sufficient power is applied to the fibre.

The second resistor can be used to tune the division of power along the length of the fibre. The higher the resistance of the second resistor, the less power will be required to cause successive length segments to switch into the on state.

In a preferred embodiment of the invention, the control means comprises a first capacitor positioned between a pair of adjacent segments.

Preferably, the control means comprises a plurality of first capacitors each of which first capacitors is positioned between respective pairs of adjacent length segments.

Advantageously, the fibre or filament further comprises a second capacitor associated with the last length segment.

An advantage of using capacitors rather than resistors is that capacitors do not in themselves dissipate power. A fibre or filament incorporating capacitors will therefore have a lower power requirement than a fibre or filament incorporating resistors.

When an AC voltage is supplied across the first and second electrodes, the capacitors will divide the voltage but they will not dissipate any power. The impedance of each capacitor (1/(2πfC_{wire})) should be lower than the equivalent impedance of the electro-optically active layer (and lower than both R_{fibre} and (1/(2πfC_{fibre}))).

Alternatively, the first or second electrode comprises a plurality of spaced apart insulators.

The plurality of insulators form capacitive connections to the length segments.

In such a fibre or filament it is not necessary to use discrete capacitors since the material used to form the first electrode contains within it, a “capacitative” material. The material forming the first electrode may comprise a light sensitive conducting material comprising an insulating porous host material filled with gold particles, for example.

The light sensitive conducting material could then be exposed to a laser causing the gold to evaporate and establish a non-conducting spacer that acts as a capacitive connection between adjacent length segments.

Advantageously, the fibre or filament comprises a plurality of first conductors positioned at spaced apart intervals along the first electrode, and a diode associated with each conductor.

Preferably, the control means comprises at least one diode associated with each of one or more length segments.

Advantageously, the fibre or filament further comprises a third electrode, and the control means further comprises at least one third capacitor associated with each of the one or more length segments, and connected to the third electrode.

The third electrode may be grounded in some embodiments.

When a low driving voltage of less than the breakdown voltage of the diodes is applied across the first and third electrodes, the diode in the first length segment behaves like a highly resistive connection. This means that all current will flow through the first fibre segment and then towards ground. This is because the impedance of the third capacitor to ground is selected to be lower than the total impedance of the electro-optically active layer. This in turn means that at low driving voltages, all power will be directed to the first length segment.

When the amplitude of the driving voltage increases beyond the threshold breakdown voltage, then the at least one diode associated with the first length segment will “break down” and start to conduct with low impedance. The excess voltage over the threshold breakdown voltage will be absorbed by the third capacitor. This raises the voltage over the third capacitor. At the same time the voltage over the second length segment will start to increase. This sequence is repeated along the entire length of the electrode.

In an alternative embodiment, the fibre or filament comprises a third resistor rather than a third capacitor connected to the third electrode. In other embodiments, the fibre or filament may comprise a combination of one or more capacitors and resistors.

Preferably, the control means comprises a plurality of conductors positioned at spaced apart intervals along the first electrode, and a diode associated with each conductor.

Advantageously, each conductor comprises an insulator. Preferably, the fibre or filament further comprises an outer insulating coating. Conveniently, the fibre or filament comprises a second conducting coating.

According to a second aspect of the present invention there is provided a method of manufacturing a fibre or filament comprising:
an electro-optically active layer;
a first electrode;
a second electrode;
the electro-optically active layer being positioned at least partially between the first and second electrodes;
the fibre or filament further comprising
control means for controllably varying the optical state of a predetermined region of the fibre or filament, such that the length of the predetermined region may be controlled;
the method comprising:
(i) coating a conducting core with an electro-optic layer and;
(ii) coating the electro-optic layer with a conducting coating such that the electro-optic layer is in contact with the conducting coating as well as the conducting core.

Preferred and advantageous features of the second aspect of the invention are set in appended claims 25 to 38.

According to a third aspect of the present invention there is provided a fabric or textile formed from a plurality of fibres or filaments.

The invention will now be further described by way of example only with reference to the accompanying drawings in which:

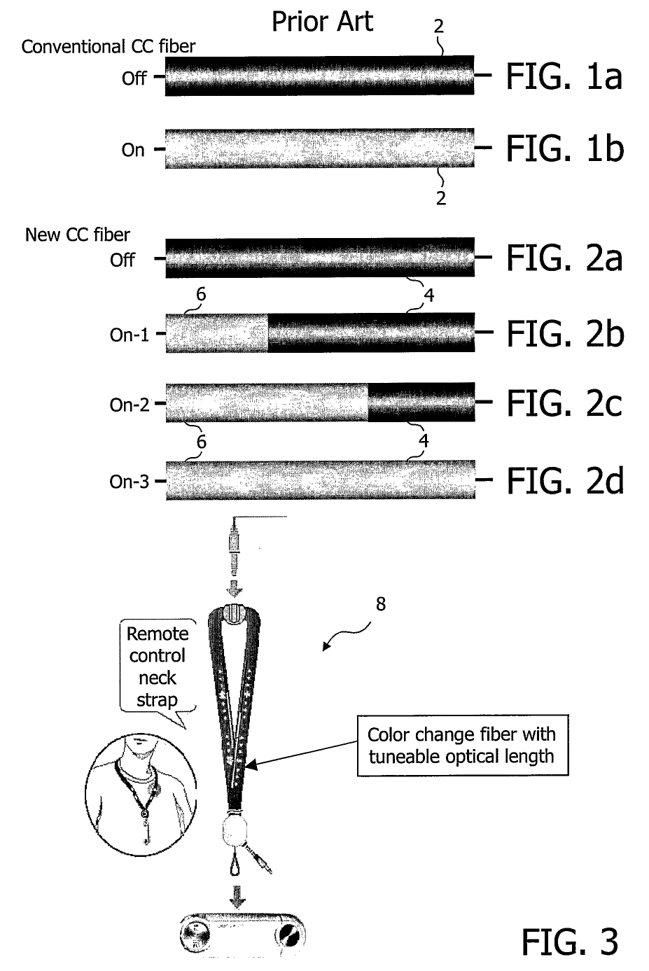

FIGS. 1a and 1b are schematic representations showing the off and on states of a conventional colour change fibre;

FIGS. 2a to 2d are schematic representations showing how the optical state of a predetermined portion of a fibre or filament according to the present invention may be varied according to the present invention;

FIG. 3 shows a fibre or filament according to a first aspect of the present invention incorporated into a neck strap serving as an indicator to monitor the state, for example a personal music system such as an MP3 player;

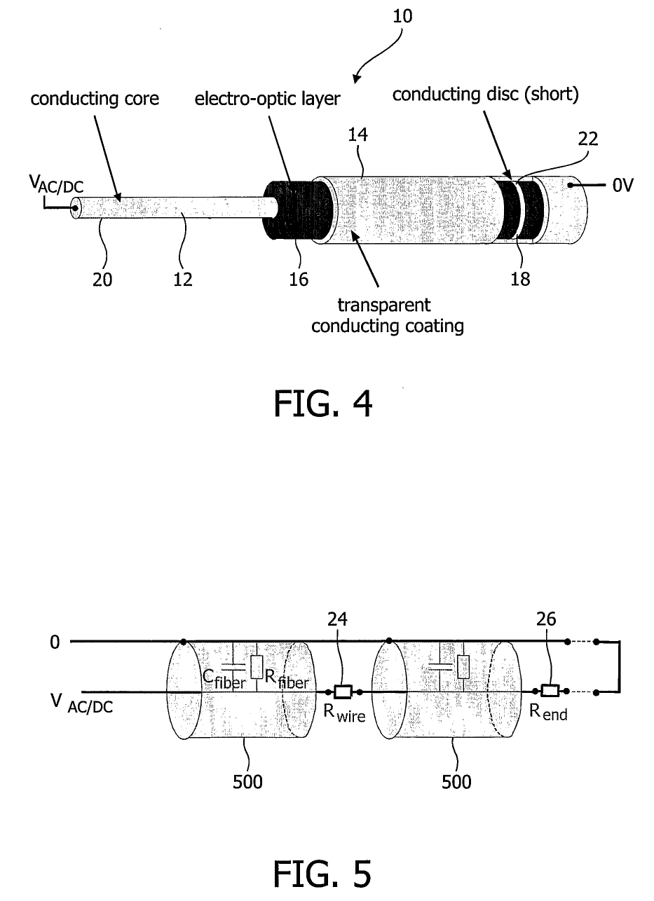

FIG. 4 is a schematic representation of a first embodiment of a fibre or filament according to the present invention;

FIG. 5 is a circuit diagram representing the fibre of FIG. 4;

FIG. 6 is a graph showing power levels for different drive voltages in segments of the circuit diagram of FIG. 5;

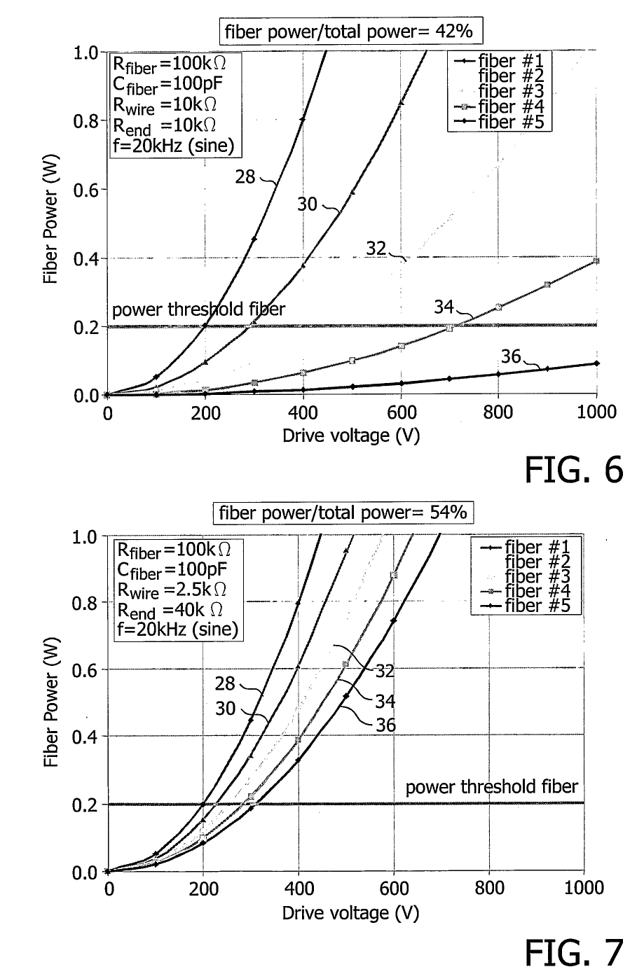

FIG. 7 is a graph showing the power distribution across segments of the circuit diagram of FIG. 5 with increased resistance associated with the last segment of the fibre;

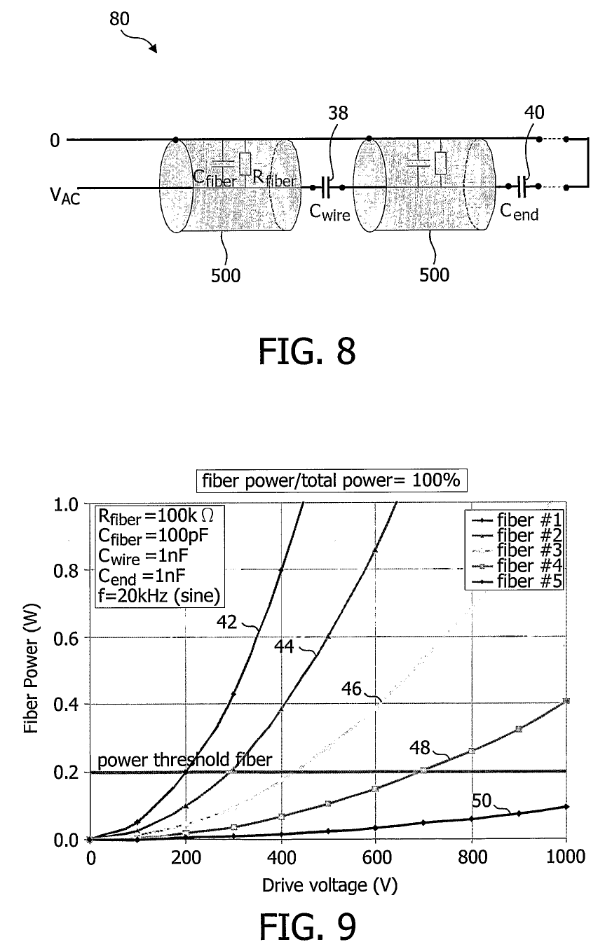

FIG. 8 is a circuit diagram representing a second embodiment of a first aspect of the present invention in which the control means comprises one or more capacitors;

FIG. 9 is a graph showing the power distribution in segments of the fibre represented by the circuit diagram of FIG. 8;

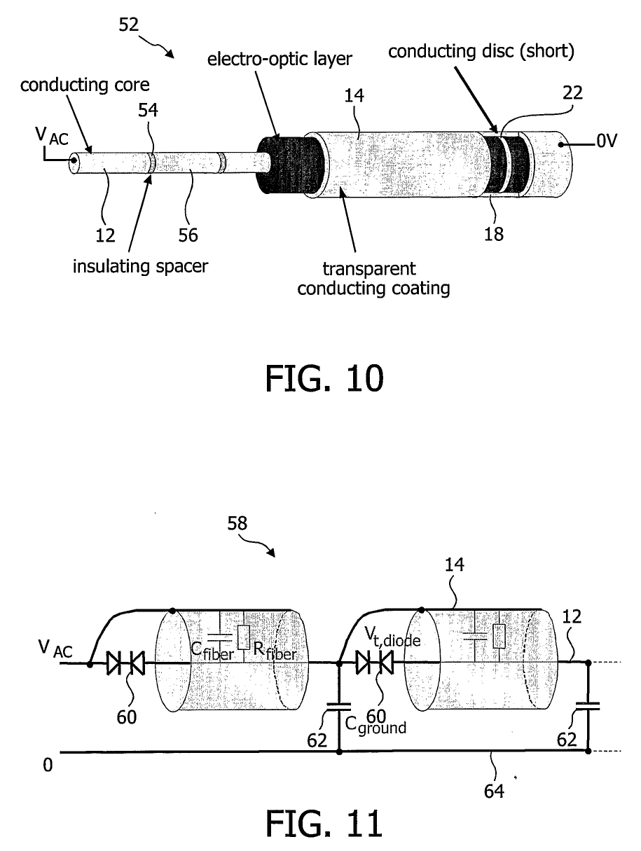

FIG. 10 is a schematic representation of a fibre according to a third embodiment of a first aspect of the present invention comprising a plurality of insulating spacers;

FIG. 11 is a circuit diagram representing a fibre according to a fourth embodiment of a first aspect of the present invention;

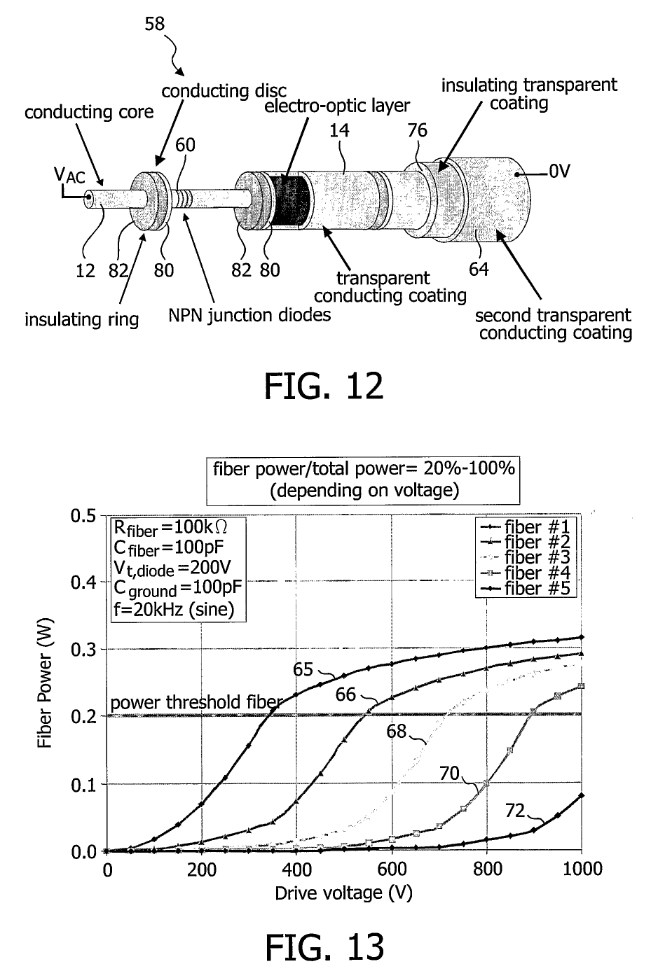

FIG. 12 is a schematic representation of a fibre according to the fourth embodiment of a first aspect of the present invention; and

FIG. 13 is a graph showing the power distribution in segments forming part of the fibre represented by the circuit diagram of FIG. 11;

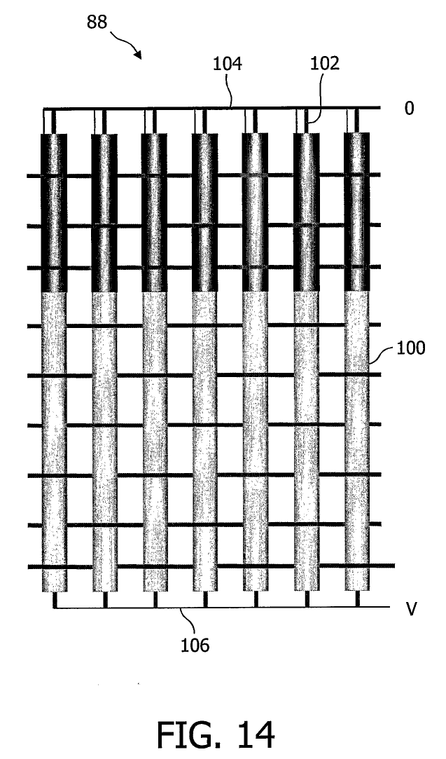

FIG. 14 is a woven fabric formed from a fibre or filament according to the first aspect of the present invention.

Referring to FIGS. 1a and 1b, a conventional colour change fibre is designated generally by the reference numeral 2. Known colour change fibres generally comprise an inner core electrode, and an outer electrode in the form of a transparent coating. Between the inner and outer electrodes is an electro-optically active material. In FIG. 1a the electro-optically active material is shown in an off state, and in FIG. 1b the electro-optically active material is shown in an on state emitting light. In conventional colour change fibres it is possible only to have the entire fibre in an on state or in an off state. In other words it is possible only to have the entire fibre either light emitting or not light emitting.

Referring to FIGS. 2a, b, c and d, a fibre according to the present invention is designated generally by the reference numeral 4. According to the present invention, as will be explained in more detail hereinbelow, it is possible to alter the optical state of a predetermined region of the fibre 4 such that the length of the predetermined region 6 may be controlled.

In FIG. 2a, the entire fibre is in an off state. In FIG. 2b a predetermined region 6 is in an on state. In FIG. 2c the predetermined region 6 is longer in length than the region 6 of FIG. 2b, and in FIG. 2d, the entire fibre is in an on state.

Thus, by means of the present invention it is possible to vary the length of the light emitting portion of the fibre 4.

Fibres according to the present invention may be used to form garments and other wearable electronics.

Turning now to FIG. 3, a neck strap 8 is shown formed from a fabric made from a plurality of fibres 4 according to the present invention. The neck strap may be used in conjunction with a personal music system such as an MP3 player to indicate various parameters of the music system, such as a track of music being played, the power capacity of the batteries, the volume, etc.

Referring now to FIG. 4 a fibre according to a first embodiment of the present invention is designated generally by the reference numeral 10. The fibre 10 comprises a first electrode in the form of a conducting core 12 and a second electrode 14 in the form of a transparent conducting coating. The fibre further comprises an electro-optically active layer 16 formed from any suitable electro-optically active material. In this embodiment the electro-optically active layer is formed from an electroluminescent material. The first electrode is formed from a material having a high resistance, for example, nichrome, which has a resistivity of ρ=11·10⁻⁷ Ωm. The fibre 10 further comprises a conducting disc 18 which serves to short the first and second electrodes 12, 14. A voltage difference is created across the first and second electrodes 12, 14. The presence of the conducting disc 18 which shorts the first and second electrodes 12, 14, means that the electric field created in the electro-optically active layers 16 decreases from a first end 20 of the fibre 10 to a second end 22 of the fibre 10.

In an alternative embodiment of the invention, the conducting core 12 is formed from a material having a lower resistance for example, copper which has a resistivity of ρ=0.17·10⁻⁷ Ωm. The first electrode 12 is divided into a plurality of length segments (not shown), including at least a first length segment positioned towards the first end 20, and a last length segment associated with the conducting disc 18 and positioned at the second end 22 of the fibre 10. Resistors are positioned between adjacent length segments of the first electrode 12. Each length segment, together with an adjacent resistor, forms a resistive element.

Each length segment of the electro-optically active layer 16 can be modelled by a parallel connection between the fibre electrodes via the resistance (R_{fibre}) and the capacitance (C_{fibre}) of the electro-optically active layer 16.

The resistance of a resistive element (R_{wire}), is chosen so that it is lower than R_{fibre}. This means that when a DC voltage is applied to the first electrode 12 the voltage will linearly divide over the length of the core electrode.

FIG. 5 shows schematically a circuit diagram equivalent to the fibre shown in FIG. 4 in the embodiment in which the first electrode 12 is divided into a plurality of length segments 500.

A first resistor 24 is positioned between adjacent length segments 500, and a second resistor 26 is associated with the conducting disc 18.

The voltage applied to the first electrode 12 may also be an AC voltage. In embodiments of the invention in which an AC voltage is applied to the first electrode 12, the impedance of each resistive element is less than the total impedance of the electro-optically active layer 16 of the corresponding length segment. In other words the impedance of each resistive element is lower than both R_{fibre} and 1/(2πfC_{fibre}).

The first electrode 12 may be formed into any convenient number of length segments 500.

Turning now to FIG. 6 the power distribution in the fibre 10 having five length segments 500 is shown.

In this embodiment of the invention, there is a power threshold of 0.2 Watts which must be overcome in order to change the optical state in any length segment such that the electro-optically active layer emits light.

The results shown in the graph of FIG. 6 were achieved using the following values of the various parameters:
R_{fibre}=100 KΩ
C_{fibre}=100 pF
R_{wire}=10 K Ω
R_{end}=10 K Ω
frequency=20 KHz (sine)

The power for each of five segments is indicated by the lines labelled 28, 30, 32, 34 and 36 respectively. It can be seen that at a drive voltage of 200 volts, the power in the first segment represented by line 28 reaches the power threshold. At this point the first length segment will emit light but no other segments will emit light.

Sequentially the optical state of the other segments will be changed so that in this example at a drive voltage of just under 300 volts, the second segment will emit light as represented by line 30, and at a drive voltage of approximately 450 volts, the third segment will emit light as indicated by line 32. At a drive voltage of approximately 700 volts, the fourth segment will also emit light as indicated by line 34. In this example shown, the drive voltage is never sufficient to allow the fifth segment to emit light.

In other words, for an increasing drive voltage, initially the first segment will switch to a light emitting state, followed by the second segment and so on. This makes use of the properties of the electroluminescent material forming the electro-optically active layer 16. Such material has a threshold power of 200 mW (per segment) below which no significant light is emitted.

If the resistance of the end resistor 26 is increased, the division of power over the segments may be tuned. The higher the resistance of resistor 26 (compared to resistor 24), the more closely spaced will become the turn on voltages of the fibre segments as shown in FIG. 7. In other words, the power threshold will be achieved in each fibre segment at a lower drive voltage, as shown in FIG. 7, which shows the power distribution for a fibre 10 in which the value of the end resistance is 40 K Ω. Other parameters are the same as those set out above in respect of FIG. 6. The lines in the graph of FIG. 7 have been given corresponding reference numerals to those of FIG. 6 for ease of reference.

In the examples shown in FIG. 7, all five length segments are in an on state at a drive voltage of approximately 300 volts.

Referring now to FIG. 8, a further embodiment of the invention is illustrated in terms of a circuit diagram equivalent to a fibre 80 or filament according to the present invention. The fibre 80 according to this embodiment has parts which are similar to the parts shown in FIGS. 4 and 5. However, rather than using resistors to divide the voltage along the length of the fibre, capacitors are used instead.

The fibre 80 is again divided into five length segments 500, and between adjacent length segments are positioned first capacitors 38. The fibre 80 further comprises a second capacitor 40 positioned towards the second end 22 of the fibre and associated with the conducting disc 18.

Referring to FIG. 9, a graphical representation of the fibre power of each of five segments 500 of fibre 80 is illustrated. Lines, 42, 44, 46, 48 and 50 represent the power in each of the five length segments respectively. In the example shown in FIG. 9, the following parameters were used:
R_{fibre}=100 KΩ
C_{fibre}=100 pF
C_{wire}=1 nF
C_{end}=1 nF
F=20 KHz (sine)

An advantage of using capacitors rather than resistors is that capacitors do not dissipate any power and therefore the power requirements of the fibre 10 using capacitors rather than resistors will be lower.

Referring to FIG. 10, a further embodiment of the present invention is shown. Parts of the fibre which correspond to parts shown in FIG. 4 have been given corresponding reference numerals for ease of reference. The fibre 52 comprises a first electrode 12 containing capacitors within it. The first electrode 12 further comprises a plurality of insulating spacers 54. The insulating spacers 54 serve to divide the first electrode 12 into a plurality of conducting cores 56. The insulating spacers 54 geometrically form a capacitive connection between adjacent conducting cores 56.

The insulating spacers 54 could for example be made by locally exposing a light sensitive conducting material to a laser, such that the conductance of the exposed areas significantly reduces at the illuminated positions. A light sensitive material could for example comprise an insulating porous host material, filled with gold particles. The exposure by a laser beam will evaporate the gold and thus establish a non-conducting spacer 54.

Referring to FIGS. 11 and 12, a fibre 58 according to a further embodiment is illustrated.

FIG. 11 is a circuit diagram representing the fibre 58, and FIG. 12 is a schematic representation of the fibre 58.

The fibre 58 comprises parts similar to those shown in FIG. 4, but additionally comprises an insulating transparent coating 76 surrounding the second electrode 14, and a third electrode 64 in the form of a second transparent conducting coating.

The fibre 58 comprises a pair of diodes 60 parallel to each length segment. The diodes are substantially identical and have a (combined) breakdown voltage of about 200V.

The pair of diodes 60 have a defined break down voltage, and connected in series with opposite forward directions. When using discrete components conventional rectifier diodes can be used (for example the Philips Semiconductor BYV27 series).

In addition, associated with each diode 60, is a short connecting the first and second electrodes 12, 14, and a third capacitor 62 that is connected to the third electrode 64.

The first electrode 12 comprises a plurality of spaced apart conducting discs 80 each of which is insulated on one side by an insulating ring 82. On the other side of the conducting disc to the insulating ring 82 the first electrode 12 comprises a pair of diodes 60. The diodes could be formed for example by using a semi-conducting base material for the conducting core, which is highly doped (either P or N type doping) except in small areas where opposite doping simultaneously creates two matched junction diodes.

The transparent conducting coating 14 contacts the non-insulated side of the discs 80. The insulating transparent coating 76 positioned between first and second transparent conducting coatings 14, 64 forms a capacitive coupling.

An alternating voltage difference is applied initially to the first length segment between the first 12 and third 64 electrodes. Due to the short between the first and second electrodes 12, 14, the alternating current potential is directed to the second electrode 14. However, the diode 60 blocks the alternating current voltage if the magnitude of the voltage is below its breakdown voltage, while the third capacitor 62 conducts the zero potential of the third electrode 64 to the first electrode 12. This means that in the first length segment of the first electrode 12, on the right side of the diode 60 the potential will be zero. This in turn means that that electro-optical material between the first 12 and second 14 electrodes will experience substantially all of the alternating current voltage applied between the first 12 and third 64 electrodes. However, in all other length segments, the potentials on the first 12 and second 14 electrodes will both be equal to a zero voltage, and therefore the electro-optical layers in those segments will not experience a voltage.

This changes when the alternating current voltage exceeds the breakdown voltage of the first diode 60. At this point the diode will transfer the part of the AC voltage level that is above its breakdown level (the over voltage) to the right side of the diode 60 in the first segment of the first electrode 12. This in turn means that the voltage over the first electro-optical layer will become equal, and limited to, the breakdown voltage of the diode. The over voltage is transferred by the short to the second electrode 14 of the second length segment. The diode of the second length segment, however, will block the over voltage as long as it is below its breakdown level, that is, when the AC voltage applied to the fibre is below a level equal to twice the breakdown level of the diodes 60.

This means that in the second length segment the first electrode 12 on the right side of the diode 60 will remain at zero potential. This in turn means that the electro-optical layer 16 in the second length segment will experience the over voltage, and therefore its optical properties will change. This will continue until the AC voltage is more than twice the breakdown level of the diodes 60 and then the third length segment forming the fibre will begin to be activated and so on along the length of the fibre.

Although FIG. 11 shows a capacitor 62 making the ground connection, resistors or a combination or capacitors and resistors could also be used. An advantage of using resistors is that it is also possible to use direct current voltage, and only one diode rather than a pair of diodes is needed. However, a fibre using resistors has less power efficiency as explained hereinabove.

In embodiment depicted in FIGS. 11 and 12, it is not necessary for the electro-optically active layer to be formed from a material having a sharp threshold. This is because the threshold is now incorporated into the non-linear conductance of the diodes, which exhibit a sharp threshold (breakdown) themselves.

Turning now to FIG. 13, the power in each of five fibre length segments forming fibre 58 shown in FIGS. 11 and 12, is illustrated graphically by lines 65, 66, 68, 70 and 72 respectively.

As can be seen from FIG. 13, the power in a given fibre segment increases until it reaches a threshold level. At the threshold level (200 volts in this example) the power in that fibre length segment starts to saturate, the additional power is transferred to the next length segment. This sequence is repeated along each of the length segments.

In the example depicted in FIG. 13 the following parameters were applied:
R_{fibre}=100 KΩ
C_{fibre}=100 pF
Vₜ diode=200 volts
C_{grounds}=100 pF
F=20 KHz (sine)

Referring now to FIG. 14, fabric 88 formed from a plurality of fibres according to the present invention is illustrated schematically.

Fabric 88 is formed from a plurality of fibres according to the first aspect of the present invention having length segments 100. Each of the length segments 100 comprises a first electrode 102 comprising a resistive material. The core electrodes 102 are connected to one another at both ends of the fibres. First and second electrodes of each length segment are shorted at end 104 of the fabric. By applying a voltage V to the first electrodes at an opposite end 106 of the fabric, the optically-active length of each of the length segments can be controlled at the same time.

1. A fibre (4) or filament comprising an electro-optically active layer (16);
a first electrode (12);
a second electrode (14);
the electro-optically active layer (16) being positioned at least partially between the first (12) and second (14) electrodes;
the fibre (4) or filament further comprising
control means for controllably varying the optical state of a predetermined region of the fibre or filament, such that the length of the predetermined region may be controlled.

2. A fibre (4) or filament according to claim 1 comprising voltage means for applying a voltage difference across the electro-optically active layer.

3. A fibre (4) or filament according to claim 2 wherein the control means controllably varies the voltage difference applied across the electro-optically active layer, along the length of the fibre or filament.

4. A fibre (4) or filament according to claim 1, wherein the fibre or filament is substantially cylindrical.

5. A fibre (4) or filament according to claim 1 wherein the first electrode (12) is positioned at or close to a central portion of the fibre or filament, and the second electrode (14) is positioned at, or close to an outer surface of the fibre or filament.

6. A fibre (4) or filament according to claim 4 wherein the first electrode (12) extends substantially along the axis of the fibre or filament.

7. A fibre (4) or filament according to claim 1 wherein the second electrode (14) comprises a first conducting coating.

8. A fibre (4) or filament according to claim 7 wherein the first conductive coating (14) is transparent.

9. A fibre (4) or filament according to claim 1 wherein the electro-optically active layer (16) comprises an electroluminescent material.

10. A fibre (4) or filament according to claim 1, wherein the control means comprises a conductor (18) extending between the first and second electrodes.

11. A fibre (4) or filament according to claim 1, wherein the first electrode (12) is divided into a plurality of length segments, comprising at least a first length segment and a last length segment positioned at or towards opposite ends of the first electrode.

12. A fibre (4) or filament according to claim 1, wherein the second electrode (14) is divided into a plurality of length segments (500), comprising at least a first length segment and a last length segment positioned at or towards opposite ends of the second electrode.

13. A fibre (4) or filament according to claim 11, wherein the control means further comprises a first resistor (24) positioned between a pair of adjacent length segments.

14. A fibre (4) or filament according to claim 11, wherein the control means further comprises a plurality of first resistors (24), each of which first resistors is positioned between respective pairs of adjacent length segments.

15. A fibre (4) or filament according to claim 11, wherein the control means further comprises a second resistor (26) associated with the last length segment.

16. A fibre (4) or filament according to claim 11, wherein the control means further comprises a first capacitor (38) positioned between a pair of adjacent length segments.

17. A fibre (4) or filament according to claim 11, wherein the control means further comprises a plurality of first capacitors (38), each of which first capacitors is positioned between respective pairs of adjacent length segments.

18. A fibre (4) or filament according to claim 11, wherein the control means further comprises a second capacitor (40) associated with the last length segment.

19. A fibre (4) or filament according to claim 16 wherein the first electrode (12) further comprises a plurality of spaced apart insulators (54).

20. A fibre (4) or filament according to claim 16, wherein the second electrode (14) comprises a plurality of spaced apart insulators (54).

21. A fibre (4) or filament according to claim 11 wherein the control means further comprises at least one diode (60) associated with each of one or more length segments.

22. A fibre (4) or filament according to claim 21 comprising a third electrode (64), the control means further comprising at least one third capacitor (62) associated with each of the one or more length segments, the third capacitor being connected to the third electrode.

23. A fibre (4) or filament according to claim 21 comprising a third electrode (64), the control means further comprising at least one third resistor associated with each of the one or more length segments, the third resistor being connected to the third electrode.

24. A method of manufacturing a fibre or filament (4) comprising:
an electro-optically active layer (16);
a first electrode (12);
a second electrode (14);
the electro-optically active layer (16) being positioned at least partially between the first (12) and second (14) electrodes;
the fibre (4) or filament further comprising
control means for controllably varying the optical state of a predetermined region of the fibre or filament, such that the length of the predetermined region may be controlled;
the method comprising:
(i) coating a conducting core (12) with an electro-optic layer (16) and;
(ii) coating the electro-optic layer with a conducting coating (14) such that the electro-optic layer is in contact with the conducting coating as well as the conducting core.

25. A method according to claim 24 comprising forming the conductive core (12) from a high resistance material.

26. A method according to claim 24 comprising placing a conductor (18) in contact with the conducting core (12).

27. A method according to claim 24 comprising the further step of:
(iii) dividing the conducting core (12) into a plurality of length segments, comprising at least a first length segment and a last length segment, positioned at or towards opposite ends of the conducting core.

28. A method according to claim 27 comprising the further step of:
(iv) inserting a first resistor (24) between at least one pair of adjacent length segments.

29. A method according to claim 27 comprising the further step of:
(v) associating a second resistor (26) with the last length segment.

30. A method according to claim 27 comprising the further step of:
(iv) inserting a first capacitor (38) between at least one pair of adjacent length segments.

31. A method according to claim 27 comprising the further step of:
(v) associating a second capacitor (40) with the last length segment.

32. A method according to claim 24 comprising the further step prior to step (i) of:
(a) forming a plurality of insulators (54) at spaced apart intervals along the conductive core.

33. A method according to claim 27 further comprising the step of:
(iv) associating at least one diode (60) with at least one length segment.

34. A method according to claim 33 comprising the further steps of:
(v) associating a third resistor with the at least one length segment;
(vi) forming a third electrode (64) substantially or partially around the fibre or filament; and
(vii) connecting the third resistor to the third electrode and one or both of the first and second electrodes.

35. A method according to claim 33 comprising the further steps of:
(v) associating a third capacitor (62) with the at least one length segment;
(vi) forming a third electrode (64) substantially or partially around the fibre or filament; and
(vii) connecting the third capacitor to the third electrode and one or both of the first and second electrodes.

36. A method according to claim 24 comprising the further steps, prior to step (i) of:
(a) placing a plurality of conductors (80) in contact with the conducting core and at spaced apart intervals along the conductive core, the conductors being connected to the conducting coating;
(b) associating a diode (60) with each conductor.

37. A method according to claim 36 comprising the further step, after step (ii) of:
(iii) applying an insulating coating (76) to the fibre or filament.

38. A method according to claim 36 comprising the further step of:
(iv) forming a third electrode by applying a second conducting coating (64) to the fibre or filament.

39. A fabric (88) or textile formed from a plurality of fibres (4) or filaments according to claim 1.

40. A garment formed from a plurality of fibres (4) or filaments according to claim 1.
